(19) United States
(12) Patent Application Publication
(10) Pub. No.: US 2021/0168241 A1
(43) Pub. Date: Jun. 3, 2021

(54) VIDEO CONFERENCE APPARATUS AND VIDEO CONFERENCE METHOD

(71) Applicant: Coretronic Corporation, Hsin-Chu (TW)

(72) Inventors: Hao-Syuan Wang, Hsin-Chu (TW); Je-Fu Cheng, Hsin-Chu (TW); Chi-Chung Hsieh, Hsin-Chu (TW); Ying-Hung Lo, Hsin-Chu (TW)

(73) Assignee: Coretronic Corporation, Hsin-Chu (TW)

(21) Appl. No.: 16/953,291

(22) Filed: Nov. 19, 2020

(30) Foreign Application Priority Data
Nov. 28, 2019 (CN) 201911188023.9

(51) Int. Cl. H04M 3/56; H04N 7/15; G06T 7/70; H04R 1/32; H04R 29/00; G06K 9/00

(52) U.S. Cl. CPC H04M 3/567; H04N 7/15; G06T 7/70; H04R 1/326; H04R 2430/20; G06K 9/00255; G06T 2207/30201; G06T 2207/20084; H04M 2203/509; H04R 29/005

(57) ABSTRACT

A video conference apparatus including an image detection device, a sound source detection device, and a processor and a video conference method are provided. The image detection device obtains a conference image of a conference space. The sound source detection device detects a sound source of the conference space and outputs a positioning signal corresponding to the sound source. The processor receives the conference image and the positioning signal to select a first sub-conference image corresponding to the sound source in the conference image according to the positioning signal. The processor detects a human face image closest to a central axis of the first sub-conference image, selects a second sub-conference image in the conference image by treating the human face image as an image center, and outputs the second sub-conference image. Therefore, an appropriate close-up conference image is automatically generated, so that a favorable video conference experience is provided.

### CROSS-REFERENCE TO RELATED APPLICATION

This application claims the priority benefit of China application serial no. 201911188023.9, filed on Nov. 28, 2019. The entirety of the above-mentioned patent application is hereby incorporated by reference herein and made a part of this specification.

### BACKGROUND

### Technical Field

The invention relates to a conference apparatus. More particularly, the invention relates to a video conference apparatus and a video conference method.

### Description of Related Art

Nowadays, as the demand for video conferences increases, how to provide a video conference apparatus design suitable for various types of conference scenarios while providing a good video effect is an important goal in the search and development of video conference apparatuses. For instance, in a video space, when one or more conference members are present, how one or a plurality of sound sources may be automatically tracked so that a corresponding conference image may be provided is an important technical issue to be overcome at present. Moreover, generally, in a conventional video conference apparatus, after a conference image is obtained, computation of a large amount of processor resources is required to perform image analysis on the captured overall conference image, so that the position of a close-up human face (the speaker) may be determined. Accordingly, several solutions of embodiments are provided as follows to provide a video conference apparatus capable of achieving the effects of automatically tracking the sound source and appropriately displaying the conference image with low data computation for image processing.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a video conference apparatus and the video conference method capable of automatically generating an appropriate close-up conference image and providing a favorable video conference experience.

In order to achieve one or a portion of or all of the objects or other objects, a video conference apparatus provided by the invention includes an image detection device, a sound source detection device, and a processor. The image detection device is configured to obtain a conference image of a conference space. The sound source detection device is configured to detect a sound source of the conference space and outputs a positioning signal corresponding to the sound source. The processor is coupled to the image detection device and the sound source detection device and is configured to receive the conference image and the positioning signal, so as to select a first sub-conference image corresponding to the sound source in the conference image according to the positioning signal. The processor performs human face detection on the first sub-conference image to detect a human face image closest to a central axis of the first sub-conference image. The processor selects a second sub-conference image in the conference image by treating the human face image as an image center and outputs the second sub-conference image.

In order to achieve one or a portion of or all of the objects or other objects, a video conference method provided by the invention includes the following steps. A conference image of a conference space is obtained through an image detection device. A sound source of the conference space is detected, and a positioning signal corresponding to the sound source is outputted through a sound source detection device. A first sub-conference image corresponding to the sound source in the conference image is selected according to the positioning signal through a processor. Human face detection is performed on the first sub-conference image to detect a human face image closest to a central axis of the first sub-conference image through the processor. A second sub-conference image in the conference image is selected by treating the human face image as an image center, and the second sub-conference image is outputted through the processor.

Based on the above, in the video conference apparatus and the video conference method provided by the invention, the conference image of the conference space may be obtained through the image detection device. Moreover, a partial conference image corresponding to the sound source in the conference image may be selected according to the positioning signal of the sound source detection device. In this way, the partial conference image may be outputted to an external display apparatus to be displayed.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block view of a video conference apparatus according to an embodiment of the invention.

FIG. 2 is a schematic view of a conference scenario according to an embodiment of the invention.

FIG. 3A is a schematic view of a first sub-conference image according to an embodiment of the invention.

FIG. 3B is a schematic view of a second sub-conference image according to an embodiment of the invention.

FIG. 4 is a flow chart of steps of a video conference method according to an embodiment of the invention.

FIG. 5 is a schematic view of a conference image according to another embodiment of the disclosure.

FIG. 6 is a schematic view of a conference image according to still another embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

In order to make the disclosure more comprehensible, several embodiments are described below as examples of implementation of the invention. Moreover, components/members/steps with the same reference numerals represent the same or similar parts in the accompanying figures and embodiments where appropriate.

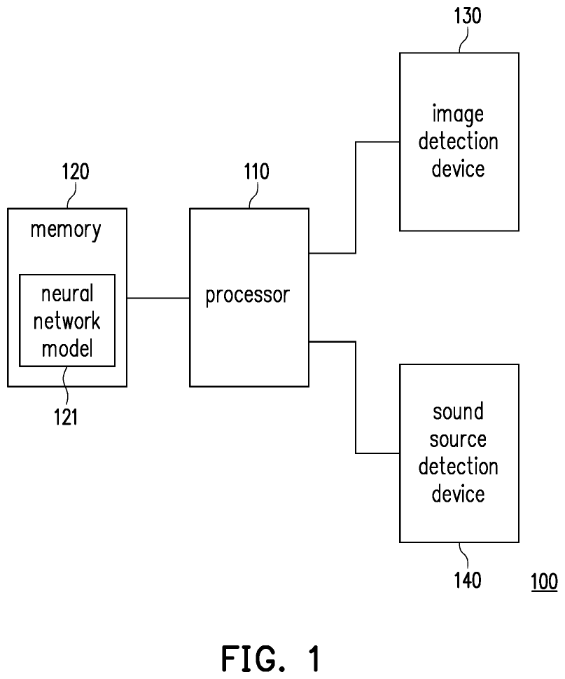

FIG. 1 is a block view of a video conference apparatus according to an embodiment of the invention. With reference to FIG. 1, a video conference apparatus 100 includes a processor 110, a memory 120, an image detection device 130, and a sound source detection device 140. The processor 110 is coupled to the memory 120, the image detection device 130, and the sound source detection device 140. The memory 120 includes a neural network (NN) model 121. In this embodiment, the image detection device 130 may be configured to obtain a conference image of a conference space and outputs the conference image to the processor 110. The conference image may include all conference members in the conference space. In an embodiment, the image detection device 130 may be a 360-degree camera, the conference image includes a 360-degree panoramic image; nevertheless, the invention is not limited thereto. The sound source detection device 140 is configured to detect a sound source of the conference space and outputs a positioning signal corresponding to the sound source to the processor 110. In an embodiment, the sound source detection device 140 may be a microphone array, the positioning signal includes sound source coordinates; nevertheless, the invention is not limited thereto.

In this embodiment, the video conference apparatus 100 may be an independent and movable apparatus and may be placed at any appropriate position in the conference space. For instance, the video conference apparatus 100 may be placed at a center of a table, a ceiling of a conference room, or the like, so as to obtain the conference image of the conference space and detect the sound source in the conference space. Nevertheless, in another embodiment, the video conference apparatus 100 may also be integrated with other computer apparatuses or display apparatuses, which is not limited by the invention. In this embodiment, the processor 110 may select a first sub-conference image corresponding to the sound source in the conference image according to the positioning signal and performs human face detection on the first sub-conference image, so as to detect a human face image closest to a central axis of the first sub-conference image. The processor 110 reselects a second sub-conference image in the conference image by treating the human face image as an image center and outputs the second sub-conference image. In other words, the processor 110 provided by the embodiment may first determine a range of the first sub-conference image in the conference image according to the conference image provided by the image detection device 130 and the positioning signal provided by the sound source detection device 140 and then determines a range of the second sub-conference image in the conference image according to a determination result of the human face detection performed on the first sub-conference image. Moreover, in the second sub-conference image outputted by the processor 110, the human face image corresponding to the sound source is located at a central position of the second sub-conference image. That is, through the video conference apparatus 100 provided by this embodiment, image processing or human face identification is not required to be performed on the entire piece of the conference image. Instead, an appropriate close-up conference image is automatically generated with low data computation for image processing.

Further, when the processor 110 provided by this embodiment performs the human face detection on the first sub-conference image, the processor 110 reads the neural network model 121 in the memory 120 and inputs the first sub-conference image into the neural network model 121, so as to identify at least one human face in the first sub-conference image through the neural network model 121. Next, the processor 110 determines the human face image closest to the central axis of the first sub-conference image according to distribution of the at least one human face in the first sub-conference image. In addition, the neural network model 121 provided by this embodiment may be trained through a plurality of reference conference images of different conference scenarios in advance, so that the trained neural network model 121 may be configured to at least identify whether a random object in the first sub-conference image is a human face. The different conference scenarios described above may refer to different conference background, different conference room brightness, or different conference objects, and so on, which is not limited by the invention.

In this embodiment, the processor 110 may include a central processing unit (CPU) exhibiting image data analysis and calculation processing functions or may include a programmable microprocessor for a general purpose or a special purpose, an image processing unit (IPU), a graphics processing unit (GPU), a digital signal processor (DSP), an application specific integrated circuits (ASIC), a programmable logic device (PLD), or other similar operational circuits or a combination these circuits. Moreover, the processor 110 is coupled to the memory 120, so as to store the neural network model 121, related image data, image analysis software, and image processing software required to implement a video conference method provided by the invention into the memory 120, so that the processor 110 may read and execute related software programs. The memory 120 may be, for example, a movable random access memory (RAM), a read-only memory (ROM), a flash memory, or a similar component or a combination of the foregoing components. In an embodiment, the video conference apparatus 100 may also be integrated with other computer apparatuses or display apparatuses, which is not limited by the invention.

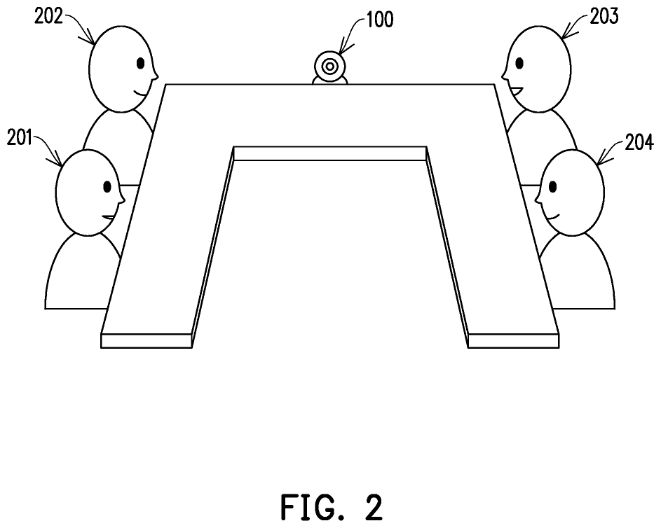

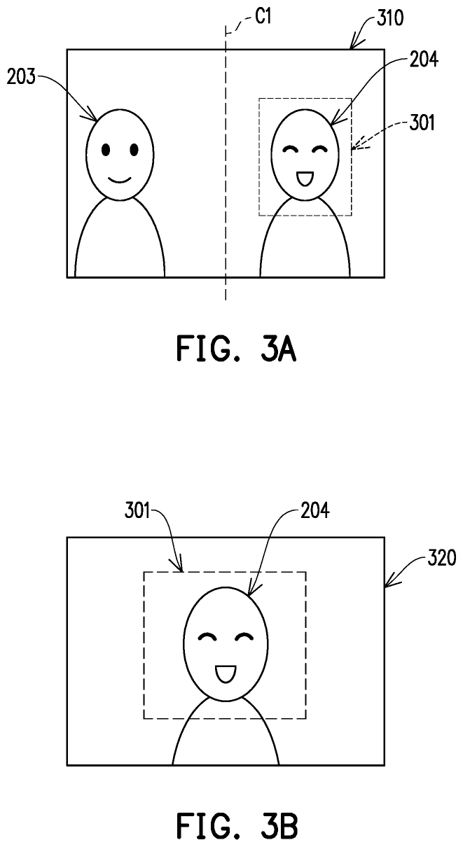

FIG. 2 is a schematic view of a conference scenario according to an embodiment of the invention. FIG. 3A is a schematic view of the first sub-conference image according to an embodiment of the invention. FIG. 3B is a schematic view of the second sub-conference image according to an embodiment of the invention. With reference to FIG. 1 to FIG. 3B, the video conference apparatus 100 may be placed on, for example, a conference table, and a plurality of conference members 201 to 204 sit next to the conference table. For instance, the image detection device 130 obtains the conference image of this conference space first. Next, when the conference member 204 speaks, the sound source detection device 140 outputs a positioning signal corresponding to the conference member 204 to the processor 110. The processor 110 thereby selects the first sub-conference image corresponding to the conference member 204 in the conference image according to the positioning signal. Nevertheless, the positioning signal provided by the sound source detection device 140 may not be completely accurate. As such, in an embodiment, the processor 110 may select a first sub-conference image 310 including the conference members 203 to 204, as shown in FIG. 3A. In this embodiment, the processor 110 performs human face detection on the first sub-conference image 310, so as to detect a human face image 301 of the conference member 204 closest to a central axis C1 of the first sub-conference image 310. Next, the processor 110 reselects a second sub-conference image 320 by treating the human face image 301 of the conference member 204 as an image center as shown in FIG. 3B and outputs the second sub-conference image 320. Accordingly, the video conference apparatus 100 may output the human face image 301 of the speaking conference member 204 in a close-up form and automatically presents the human face image 301 of the conference member 204 in a middle position of an outputted image.

Besides, in another embodiment, the processor 110 of the video conference apparatus 100 may further judge whether the human face image 301 of the conference member 204 in the second sub-conference image 320 is greater than a first image range threshold or less than a second image range threshold, so as to perform an image scaling operation based on the human face image 301 acting as the center, and outputs the scaled second sub-conference image 310.

In other words, the video conference apparatus 100 may automatically and appropriately adjust an image size of the human face image 301 in the second sub-conference image 320 according to a distance between the speaking conference member 204 and the video conference apparatus 100, so that an appropriate human face close-up image of the speaker is provided. Nevertheless, the first image range threshold and the second image range threshold may be judged according to a display resolution of an external display apparatus, which is not limited by the invention.

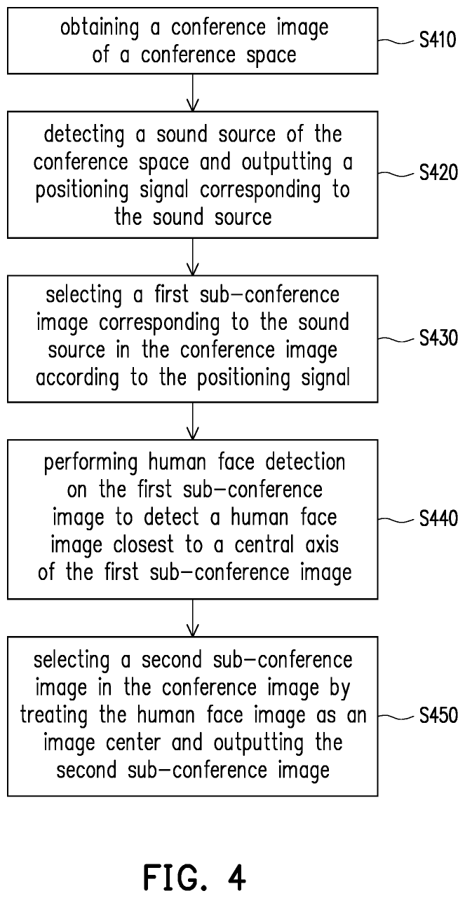

FIG. 4 is a flow chart of steps of a video conference method according to an embodiment of the invention. With reference to FIG. 1 and FIG. 4, a video conference method provided by this embodiment may at least be applied to the video conference apparatus 100 of the embodiments of FIG. 1. In step S410, the image detection device 130 obtains a conference image of a conference space. In step S420, the sound source detection device 140 detects a sound source of the conference space and outputs a positioning signal corresponding to the sound source. In step S430, the processor 110 selects a first sub-conference image corresponding to the sound source in the conference image according to the positioning signal. In step S440, the processor 110 performs human face detection on the first sub-conference image to detect a human face image closest to a central axis of the first sub-conference image. In step S450, the processor 110 selects a second sub-conference image in the conference image by treating the human face image as an image center and outputs the second sub-conference image. Therefore, the video conference method and the video conference apparatus 100 of this embodiment may automatically provide an appropriate close-up conference image.

In addition, sufficient teachings, suggestions, and implementation description related to implementation, variation, and extension of each step of this embodiment may be acquired with reference to the description of the embodiments of FIG. 1 to FIG. 3B, and that repeated description is not provided hereinafter.

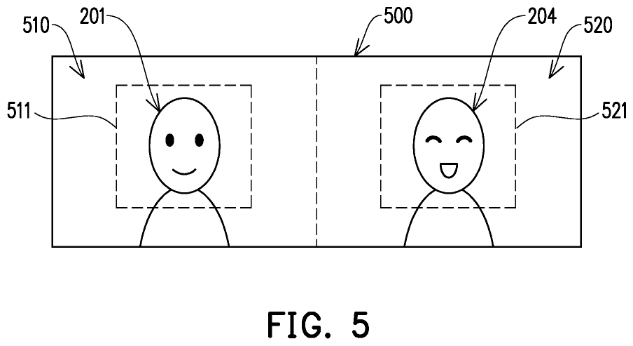

FIG. 5 is a schematic view of a conference image according to another embodiment of the disclosure. With reference to FIG. 1 again, in another embodiment, when the sound source detection device 140 detects a plurality of sound sources, the sound source detection device 140 outputs a plurality of positioning signals corresponding to the plurality of sound sources to the processor 110. The processor 110 thereby respectively selects a plurality of first sub-conference images corresponding to the plurality of sound sources in the conference image according to the plurality of positioning signals. Moreover, the processor 110 respectively performs human face detection on the plurality of first sub-conference images to respectively detect a plurality of human face images closest to central axes of the plurality of first sub-conference images. The processor 110 selects a plurality of second sub-conference images in the conference image by respectively treating the plurality of human face images as image centers. The processor 110 combines and outputs the plurality of second sub-conference images.

Therefore, with reference to FIG. 1, FIG. 2, and FIG. 5, for instance, if the conference members 201 and 204 both speak, the sound source detection device 140 may respectively provide two positioning signals of the two conference members 201 and 204 to the processor 110. The processor 110 may thereby determine two second sub-conference images 510 and 520 according to the two positioning signals (detailed steps can be found with reference to the description above). Moreover, the processor 110 treats the two second sub-conference images 510 and 520 as two horizontally-divided frames to be combined and outputted as a current conference image 500. Note that implementation similar to that of the embodiments of FIG. 3A and FIG. 3B may be deduced. Human face images 511 and 521 of the conference members 201 and 204 are respectively located at centers of two divided frames. Accordingly, the video conference apparatus 100 of another embodiment may provide a plurality of appropriate close-up conference images presenting and corresponding to multiple speakers together.

In addition, sufficient teachings, suggestions, and implementation description related to implementation, variation, and extension of the video conference apparatus of this embodiment may be acquired with reference to the description of the embodiments of FIG. 1 to FIG. 4, and that repeated description is not provided hereinafter.

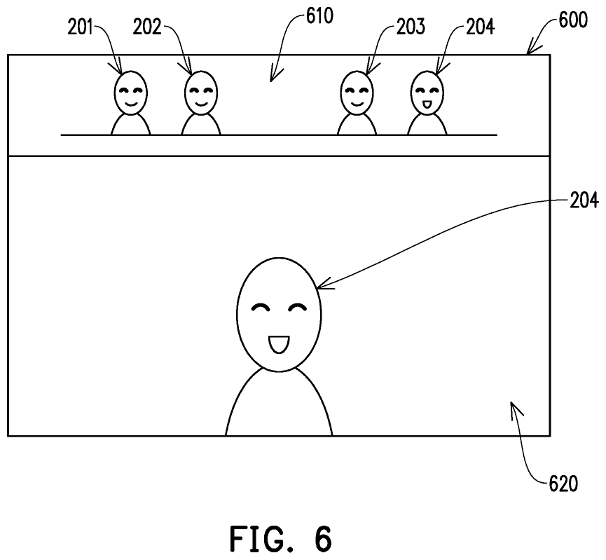

FIG. 6 is a schematic view of a conference image according to still another embodiment of the disclosure. With reference to FIG. 1 and FIG. 6, in still another embodiment, when the processor 110 performs the method similar to that provided in the embodiments of the foregoing FIG. 3A and FIG. 3B and obtains a second sub-conference image 620 in which the human face image of the conference member 204 is located in the middle, the processor 110 may further treat the second sub-conference image 620 and a conference image 610 as two vertically-divided frames as shown in FIG. 6 to be combined and outputted as a current conference image 600. In other words, a panoramic conference image and a close-up conference image may be combined and outputted by the processor 110, so that an overall conference image (e.g., the panoramic conference image) including all conference members 201 to 204 and a close-up image of the speaking member 204 may be included and presented together in the current conference image 600. Accordingly, the video conference apparatus 100 of still another embodiment may provide another appropriate close-up conference image.

In addition, sufficient teachings, suggestions, and implementation description related to implementation, variation, and extension of the video conference apparatus of this embodiment may be acquired with reference to the description of the embodiments of FIG. 1 to FIG. 5, and that repeated description is not provided hereinafter.

In view of the foregoing, in the video conference apparatus and the video conference method provided by the invention, the panoramic conference image of the conference space may be obtained through the image detection device. Moreover, a partial conference image corresponding to the sound source and captured from the panoramic conference image may be determined according to the positioning signal of the sound source detection device. Herein, the human face image of the speaker corresponding to the sound source is automatically centered in the middle of the partial conference image. Therefore, in the video conference apparatus and the video conference method provided by the invention, an appropriate close-up conference image may be automatically generated, so that a favorable video conference experience is provided.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A video conference apparatus, wherein the video conference apparatus comprises an image detection device, a sound source detection device, and a processor, wherein
the image detection device is configured to obtain a conference image of a conference space,
the sound source detection device is configured to detect a sound source of the conference space and outputs a positioning signal corresponding to the sound source, and
the processor is coupled to the image detection device and the sound source detection device and is configured to receive the conference image and the positioning signal, so as to select a first sub-conference image corresponding to the sound source in the conference image according to the positioning signal,
wherein the processor performs human face detection on the first sub-conference image to detect a human face image closest to a central axis of the first sub-conference image, wherein the processor selects a second sub-conference image in the conference image by treating the human face image as an image center and outputs the second sub-conference image.

2. The video conference apparatus as claimed in claim 1, wherein the processor inputs the first sub-conference image in a neural network model to identify at least one human face in the first sub-conference image, and the processor judges the human face image closest to the central axis of the first sub-conference image according to distribution of the at least one human face in the first sub-conference image.

3. The video conference apparatus as claimed in claim 2, wherein the neural network model is trained through a plurality of reference conference images of different conference scenarios in advance, so as to be configured to at least identify whether a random object in the first sub-conference image is a human face.

4. The video conference apparatus as claimed in claim 1, wherein the processor judges whether the human face image in the second sub-conference image is greater than a first image range threshold or less than a second image range threshold to perform an image scaling operation based on the human face image acting as the center and outputs the scaled second sub-conference image.

5. The video conference apparatus as claimed in claim 4, wherein the processor is coupled to an external display apparatus, and the first image range threshold and the second image range threshold are determined according to a display resolution of the external display apparatus.

6. The video conference apparatus as claimed in claim 1, wherein the processor further outputs the conference image to treat the second sub-conference image and the conference image as two vertically-divided frames to be combined and outputted as a current conference image.

7. The video conference apparatus as claimed in claim 1, wherein the sound source detection device outputs a plurality of positioning signals corresponding to a plurality of sound sources to the processor when the sound source detection device detects the plurality of sound sources, so that the processor respectively selects a plurality of first sub-conference images corresponding to the plurality of sound sources in the conference image according to the plurality of positioning signals,
wherein the processor respectively performs human face detection on the plurality of first sub-conference images to respectively detect a plurality of human face images closest to central axes of the plurality of first sub-conference images, wherein the processor selects a plurality of second sub-conference images in the conference image by respectively treating the plurality of human face images as image centers, and the processor combines and outputs the plurality of second sub-conference images.

8. The video conference apparatus as claimed in claim 7, wherein the processor treats the plurality of second sub-conference images as a plurality of horizontally-divided frames to be combined and outputted as a current conference image, and the plurality of human face images are respectively located at centers of the divided frames.

9. The video conference apparatus as claimed in claim 1, wherein the image detection device is a 360-degree camera, and the conference image comprises a 360-degree panoramic image.

10. The video conference apparatus as claimed in claim 1, wherein the sound source detection device is a microphone array, and the positioning signal comprises sound source coordinates.

11. A video conference method, comprising:
obtaining a conference image of a conference space through an image detection device;
detecting a sound source of the conference space and outputting a positioning signal corresponding to the sound source through a sound source detection device;
selecting a first sub-conference image corresponding to the sound source in the conference image according to the positioning signal through a processor;
performing human face detection on the first sub-conference image to detect a human face image closest to a central axis of the first sub-conference image through the processor; and
selecting a second sub-conference image in the conference image by treating the human face image as an image center and outputting the second sub-conference image through the processor.

12. The video conference method as claimed in claim 11, wherein the step of performing the human face detection on the first sub-conference image to detect the human face image closest to the central axis of the first sub-conference image through the processor further comprises:
inputting the first sub-conference image in a neural network model to identify at least one human face in the first sub-conference image through the processor; and
determining the human face image closest to the central axis of the first sub-conference image according to distribution of the at least one human face in the first sub-conference image through the processor.

13. The video conference method as claimed in claim 12, wherein the neural network model is trained through a plurality of reference conference images of different conference scenarios in advance, so as to be configured to at least identify whether a random object in the first sub-conference image is a human face.

14. The video conference method as claimed in claim 11, wherein the step of selecting the second sub-conference image in the conference image by treating the human face image as the image center and outputting the second sub-conference image through the processor further comprises:
judging whether the human face image in the second sub-conference image is greater than a first image range threshold or less than a second image range threshold to perform an image scaling operation based on the human face image acting as the center and outputting the scaled second sub-conference image through the processor.

15. The video conference method as claimed in claim 14, wherein the processor is coupled to an external display apparatus, and the first image range threshold and the second image range threshold are determined according to a display resolution of the external display apparatus.

16. The video conference method as claimed in claim 11, wherein the video conference method further comprises:
further outputting the conference image to treat the second sub-conference image and the conference image as two vertically-divided frames to be combined and outputted as a current conference image through the processor.

17. The video conference method as claimed in claim 11, wherein the video conference method further comprises:
outputting a plurality of positioning signals corresponding to a plurality of sound sources to the processor through the sound source detection device when the sound source detection device detects the plurality of sound sources, so that the processor respectively selects a plurality of first sub-conference images corresponding to the plurality of sound sources in the conference image according to the plurality of positioning signals;
respectively performing human face detection on the plurality of first sub-conference images to respectively detect a plurality of human face images closest to central axes of the plurality of first sub-conference images through the processor, wherein the processor selects a plurality of second sub-conference images in the conference image by respectively treating the plurality of human face images as image centers; and
combining and outputting the plurality of second sub-conference images through the processor.

18. The video conference method as claimed in claim 17, wherein the video conference method further comprises:
treating the plurality of second sub-conference images as a plurality of horizontally-divided frames to be combined and outputted as a current conference image by the processor, wherein the plurality of human face images are respectively located at centers of the divided frames.

19. The video conference method as claimed in claim 11, wherein the image detection device is a 360-degree camera, and the conference image comprises a 360-degree panoramic image.

20. The video conference method as claimed in claim 11, wherein the sound source detection device is a microphone array, and the positioning signal comprises sound source coordinates.
